(19) United States
(12) Patent Application Publication
(10) Pub. No.: US 2010/0126275 A1
(43) Pub. Date: May 27, 2010

(54) SELF-CALIBRATING ULTRASOUND SYSTEMS AND METHODS

(76) Inventors: Greg Leyh, Brisbane, CA (US); Justin May, Redwood City, CA (US); Tonee Smith, Redwood City, CA (US)

Correspondence Address: Cutera c/o MoFo, 425 Market Street, San Francisco, CA, 94105-2482, US

(21) Appl. No.: 12/276,642

(22) Filed: Nov. 24, 2008

(51) Int. Cl. G01H 13/00; G01N 29/00

(52) U.S. Cl. 73/579; 73/1.82

(57) ABSTRACT

Systems, apparatus, and methods for controlling acoustic power delivery at ultrasonic frequencies. An embodiment of the invention comprises an ultrasonic device including an ultrasonic transducer and an acoustic sensor having a fixed acoustic coupling to the transducer. A method of the invention may include sensing acoustic power output from the ultrasonic transducer in response to a calibration signal, and determining a drive frequency for a working drive signal to enable efficient and controllable operation of the transducer. The invention may be used for automatically re-calibrating ultrasound systems for optimum performance at frequencies including the range of 3 to 12 MHz.

### FIELD OF THE INVENTION

The present invention generally relates to ultrasound systems and methods for controlling power delivery.

### BACKGROUND OF THE INVENTION

Ultrasound systems find a wide range of applications, for example, in industrial processes and medical procedures. The acoustic power output from ultrasonic devices may be used, for example, in medical procedures for imaging, diagnosis, or treatment of a human body, as well as in non-medical applications, e.g., for inspection and flaw detection of metal and/or ceramic components.

Ultrasound devices of the prior art typically include a transducer that converts electrical energy into acoustical energy via vibrational motion at ultrasonic frequencies (i.e., approximately ≧20 KHz). The ultrasonic vibration is induced by exciting one or more piezoelectric elements of the transducer by an electrical signal. The electrical signal, e.g., high frequency voltage, is transmitted to a pair of electrodes coupled to the piezoelectric element(s), whereby an electric field established across the piezoelectric element(s) generates a mechanical standing wave at a frequency approximately equal to the frequency of the electrical excitation signal. Acoustic energy from the ultrasonic device may be delivered, for example, to a targeted tissue or organ of a patient, or to a mechanical component for inspection and flaw detection.

Prior art ultrasound systems typically include an ultrasonic device, such as a probe or handpiece. The device is typically driven by a generator or power supply which provides the electrical signal to drive oscillation of the ultrasonic transducer. Ultrasound systems of the prior art typically further include a processor that controls the generator and therefore operation of the device. Conventional ultrasound systems may still further include a display, a user interface, and the like.

A problem often encountered during operation of conventional ultrasonic devices is frequency drift. For efficient operation, ultrasonic transducers typically require drive frequencies within a relatively narrow range. This range can vary with temperature, drive level, and from transducer to transducer. In the absence of compensation by a drive unit to adjust the drive frequency according to variations in resonant frequency of the transducer, the efficiency of the ultrasound device decreases following any significant frequency drift. Frequency drift may be caused by changes in operating conditions, e.g., temperature changes during operation, as well as with extended use over the lifetime of the device. Frequency drift can be aggravated by operation at high peak power levels, and/or high DC bias settings.

Ultrasonic transducers can be expected to undergo significant resonant frequency drift even when the frequency of the ultrasonic transducer has been precisely adjusted at the time of manufacture. If the resonant frequency of the ultrasonic transducer shifts in the absence of compensatory adjustment of the drive frequency, the device operates inefficiently, and at the same time, the level of acoustic power may vary such that the level of acoustic power being delivered to a patient, object, or component under examination or treatment is not accurately known, resulting in an ineffective or failed procedure or process.

Due to the prevalence of frequency drift, including significant drift occurring during operation of the device, it is highly desirable to adjust the drive frequency according to changes in resonant frequency of the ultrasonic transducer. Such adjustment of drive frequency is required not only to provide efficient operation of the ultrasonic device, but also to control the level of acoustic power delivery. As an example, in medical applications of ultrasound in which the ultrasonic transducer may be used to deliver acoustic energy to one or more portions of a patient's body, e.g., a particular organ or tissue, it is highly desirable to operate the ultrasonic device at uniformly high efficiency and at a controlled acoustic power level.

Accordingly, attempts have been made in the prior art to monitor resonant frequency drift in ultrasound systems by measuring system electrical parameters as a means to identify the resonant frequency of the ultrasonic transducer. For example, U.S. Pat. No. 5,735,280 to Sherman et al. discloses an ultrasonic electrophysiological ablation catheter, wherein a series- and parallel resonant frequency of a low Q transducer are determined by monitoring current and voltage output to the catheter. The transducer is operated at the average of the series and parallel resonant frequency.

U.S. Pat. No. 5,808,396 to Bouhkny discloses a system and method for controlling ultrasonic handpieces by incorporating a broad spectrum signal to drive the handpieces. Series resonance and parallel resonance are identified by Bouhkny as the frequencies corresponding to the maximum and minimum admittances, respectively.

U.S. Pat. No. 6,678,621 to Wiener et al. discloses an ultrasonic handpiece, having a longitudinally vibrating blade driven at an output displacement that is correlated with phase margin, which is the difference between the resonant and anti-resonant frequencies of the handpiece. The resonant and anti-resonant frequencies of the handpiece are determined as points, during a frequency sweep, that correspond to minimum and maximum impedance, respectively, of the handpiece.

Methods for characterizing a transducer by monitoring output power draw from the amplifier or output waveforms during a frequency sweep to locate the actual resonant and anti-resonant nodes, according to the prior art, may be useful for devices operating at relatively low frequencies (e.g., <5 MHz), since at such frequencies the resonant and anti-resonant nodes are relatively well defined and clearly visible by measuring the transducer impedance (or admittance). A disadvantage with such prior art methods is that they are not applicable to ultrasonic devices and systems operating at higher frequencies, e.g., >7 MHz, since at these frequencies the resonant and anti-resonant nodes are not well defined. Thus, methods and apparatus of the prior art may not provide for the efficient operation of high frequency ultrasound systems, nor adequately control acoustic power delivery, e.g., to a patient undergoing diagnosis or treatment.

It can be seen, therefore, that there is a need for an ultrasound system that functions efficiently by adjusting the frequency for driving an ultrasonic transducer of the system. There is a further need for an ultrasound system in which acoustic power levels delivered by an ultrasonic transducer can be accurately controlled. There is still a further need for a method for tuning an ultrasound system for optimum acoustic power delivery at high operating frequencies.

### SUMMARY OF THE INVENTION

According to one aspect of the invention, a method for controlling a power supply of an ultrasound system comprises sensing acoustic power output from an ultrasonic transducer via an acoustic sensor, and controlling a drive frequency of the power supply in response to the sensed acoustic power output.

According to another aspect of the invention there is provided a method for tuning a power supply, the method comprising providing a calibration signal to an ultrasonic transducer; via an acoustic sensor, sensing acoustic power outputted from the ultrasonic transducer in response to the calibration signal; based on the sensed acoustic power, determining an optimum drive frequency value for the ultrasonic transducer; and based on the optimum drive frequency value, driving the ultrasonic transducer at a selected drive frequency, wherein the selected drive frequency provides at least substantially optimum acoustic power output from the ultrasonic transducer.

According to another aspect of the invention there is provided a method for tuning a power supply, the method comprising providing a calibration signal to an ultrasonic transducer; via an acoustic sensor, sensing acoustic power outputted from the ultrasonic transducer in response to the calibration signal; and based on the sensed acoustic power, determining a resonant frequency value of the ultrasonic transducer.

According to a further aspect of the invention, a method for selecting drive frequency in a self-calibrating ultrasound system comprises providing a calibration signal to an ultrasonic transducer of the ultrasound system; via an acoustic sensor, sensing an acoustic power output level from the ultrasonic transducer in response to the calibration signal; comparing the acoustic power output level for each of a plurality of frequencies within a frequency range of the calibration signal; based on the comparing step, and determining an optimum drive frequency value for the ultrasonic transducer.

According to yet another aspect of the invention, there is provided a method of operating an ultrasound device for treatment of tissue, wherein the ultrasound device includes an ultrasound transducer and a power supply generating a high frequency output. The method comprises driving the transducer over a range of operating frequencies; monitoring the output of the transducer with an acoustic sensor and generating output signals in response thereto; selecting an optimum drive frequency based on the output signals; and driving the transducer at the optimum drive frequency during the treatment of the tissue.

According to still another aspect of the invention, an ultrasonic device comprises a transducer assembly including an ultrasonic transducer, and an acoustic sensor having a fixed acoustic coupling to the ultrasonic transducer. The acoustic sensor has a frequency response extending over at least an operating frequency range of the ultrasonic transducer. The ultrasonic transducer is configured for receiving a calibration signal comprising a calibration frequency range, and the acoustic sensor is configured for sensing acoustic power output from the ultrasonic transducer for each of a plurality of frequencies within the calibration frequency range.

According to still a further aspect of the invention, there is provided a system comprising a power supply, an ultrasonic transducer coupled to the power supply, an acoustic sensor acoustically coupled to the ultrasonic transducer, and a re-calibration circuit coupled to the acoustic sensor and to the power supply. The ultrasonic transducer is configured for receiving a calibration signal comprising a calibration frequency range, and the acoustic sensor is configured for sensing acoustic power output from the ultrasonic transducer for each of a plurality of frequencies within the calibration frequency range.

These and other features, aspects, and advantages of the present invention may be further understood with reference to the drawings, description, and claims which follow.

### BRIEF DESCRIPTION OF THE DRAWINGS

FIG. 1 is a block diagram schematically representing an ultrasound system, according to an embodiment of the instant invention;

FIG. 2A schematically represents an ultrasound system, according to another embodiment of the invention;

FIG. 2B schematically represents an ultrasound system, according to another embodiment of the invention;

FIG. 3 is a block diagram schematically representing an ultrasonic device, according to another embodiment of the invention;

FIG. 4A is a flow chart schematically representing steps in a method for controlling a power supply of an ultrasound system, according to another embodiment of the invention;

FIG. 4B is a flow chart schematically representing steps in a method for controlling a power supply of an ultrasound system, according to another embodiment of the invention;

FIG. 5 is a flow chart schematically representing steps in a method for controlling a power supply, according to another embodiment of the invention; and

FIG. 6 is a flow chart schematically representing steps in a method for calibrating an ultrasound system, according to another embodiment of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides systems, apparatus, and methods for controlling ultrasonic acoustic power delivery. As a non-limiting example, the instant invention may be used to dynamically adjust a drive signal in an ultrasound system, whereby acoustic power delivery by the ultrasound system is optimized. Further, the instant invention allows repeated re-calibration to occur automatically during operation of the ultrasound system, without operator intervention, to maintain peak performance of the system. By regularly monitoring acoustic power output by the ultrasonic transducer in response to a calibration signal, and adjusting the frequency of the drive signal accordingly, the ultrasonic device can be operated at high efficiency, and at the same time a controlled acoustic power level can be delivered by the ultrasonic device. The invention may find applications in a broad range of medical procedures and non-medical processes.

In contrast to the present invention, prior art methods have used electrical parameters for tracking resonant frequency, for example, the monitoring of maximum and minimum impedance values to indicate parallel and series resonance frequencies. Unlike the present invention, such prior art methods are not useful for monitoring transducer resonant frequency in devices operating above about 5 MHz, nor for determining optimum drive frequency values for such devices.

Unlike prior art systems and methods, the present invention uses an acoustic sensor for sensing acoustic power output as a basis for determining an optimum drive frequency for an ultrasonic transducer. In an embodiment of the present invention, the ultrasonic transducer may be disposed within a transducer assembly of an ultrasonic device, and the acoustic sensor may be integral with the transducer assembly. The acoustic sensor may have a fixed acoustic coupling to the ultrasonic transducer. In further contrast to prior art systems and methods, the invention is applicable to ultrasound systems operating at frequencies above 5 MHz, for example, from about 7-30 MHz.

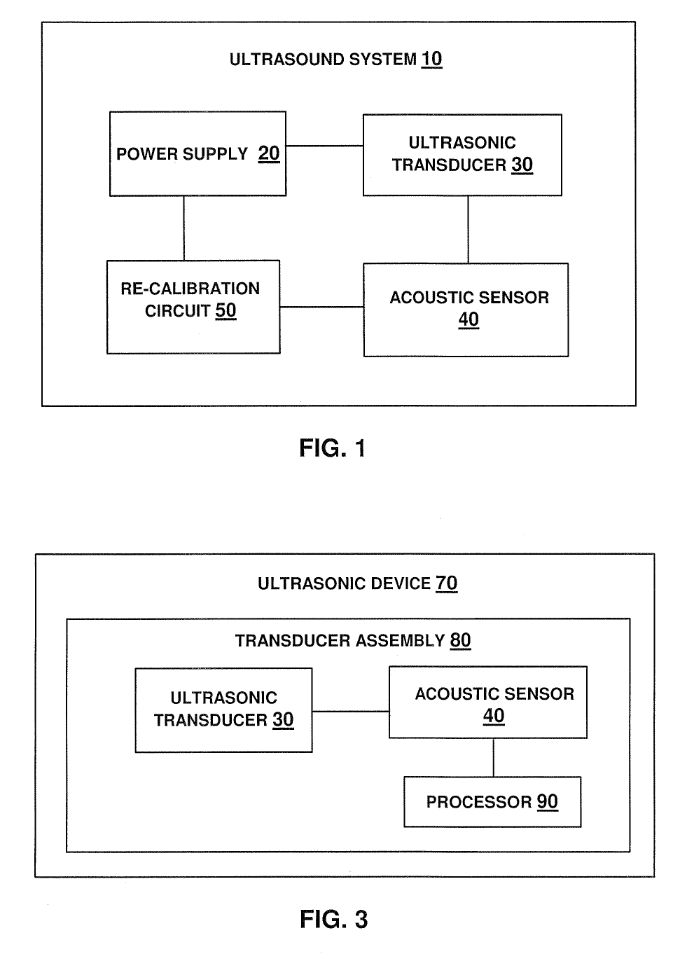

FIG. 1 schematically represents an ultrasound system 10, according to an embodiment of the instant invention. Ultrasound system 10 may include a power supply 20, an ultrasonic transducer 30, an acoustic sensor 40, and a re-calibration circuit 50. Ultrasonic transducer 30 may be coupled to power supply 20, for example, by a suitable electrical connection, such as one or more cables. Power supply 20 may comprise, inter alia, an oscillator and an amplifier (not shown). Power supply may provide a high frequency AC voltage to ultrasonic transducer 30. Power supply 20 may also be referred to as a drive unit. Various ultrasound power signal generators are disclosed in commonly assigned, co-pending patent application Ser. No. 11/851,351, entitled Ultrasound system and method for hair removal (US Patent Application Publication No. 2008/0183110), the disclosure of which is incorporated by reference herein in its entirety for all purposes. It is to be understood, however, that the instant invention is not limited to any particular power supply configuration.

Again with reference to FIG. 1, power supply 20 may be configured for providing a calibration signal to ultrasonic transducer 30 for driving ultrasonic transducer 30 at a plurality of frequencies within a calibration frequency range. Power supply 20 may be further configured for providing a working drive signal to ultrasonic transducer 30 for driving ultrasonic transducer 30 at a selected drive frequency, fₛ. According to an aspect of the instant invention, the drive frequency may be selected to provide at least substantially optimum acoustic power output from ultrasonic transducer 30. A drive frequency that provides optimum acoustic power output from ultrasonic transducer 30 may be referred to herein as the optimum drive frequency value, fₒ. The selected drive frequency may typically be in the range of ±10% of the optimum drive frequency value, usually in the range of ±5% of the optimum drive frequency value, and often in the range of ±2% of the optimum drive frequency value. In an embodiment, the selected drive frequency may be at least substantially equal to the optimum drive frequency value.

In an embodiment, the optimum drive frequency may typically be in the range of from about 3 MHz to 12 MHz, usually from about 6 MHz to 12 MHz, and often at least about 7 MHz.

In an embodiment, the calibration signal may comprise a relatively low drive level, e.g., comprising a relatively low voltage signal from power supply 20. The working drive signal may be at a substantially higher level, e.g., may have a substantially higher voltage, than the calibration signal. Provision of both the working drive signal and the calibration signal may be controlled by re-calibration circuit 50.

Ultrasonic transducer 30 may have a resonant frequency, which may be designated f_{R}. In an embodiment, f_{R} may typically be ≧5 MHz, often f_{R} may be ≧7 MHz, and in some embodiments of the invention, f_{R} may be in the range of about 7-30 MHz. The resonant frequency of ultrasonic transducer 30 is subject to drift, e.g., with changing environmental conditions, including variations in temperature. Accordingly, a resonant frequency of ultrasonic transducer 30 may vary over a range of values. Changes in resonant frequency may be monitored by repeated determination of resonant frequency values according to methods of the instant invention, and the drive frequency to ultrasonic transducer 30 may undergo compensatory adjustment. Thus, the operating frequency of ultrasonic transducer 30 may similarly vary over a range of values.

The calibration signal provided to ultrasonic transducer 30 by power supply 20 may include a plurality of frequencies within a calibration frequency range. The plurality of frequencies of the calibration signal may span at least a resonant frequency range of ultrasonic transducer 30. As an example, the calibration frequency range of the calibration signal may be ±10% of a resonant frequency value of ultrasonic transducer 30. Ultrasonic transducer 30 may provide a variable acoustic power output according to various frequencies, e.g., within the calibration signal, at which ultrasonic transducer 30 is driven. A maximum acoustic power output from ultrasonic transducer 30 may occur when ultrasonic transducer 30 is driven at a frequency within the calibration signal corresponding to the resonant frequency of ultrasonic transducer 30.

In an embodiment, a drive frequency may be selected other than the resonant frequency of ultrasonic transducer 30, and system 10 may be operated at a sub-maximal power level. For example, ultrasonic transducer 30 may be driven at an optimum drive frequency to provide optimum acoustic power output at a power level close to maximum for a particular system 10, but in the absence of an unacceptable level of distortion. Typically, for example, a level of distortion may be deemed acceptable when the distortion is not more than about 10% of maximum distortion, usually not more than about 7% of maximum distortion, and often not more than about 5% of maximum distortion. In an embodiment, the calibration frequency range may span at least the optimum drive frequency value for ultrasonic transducer 30. For example, the calibration frequency range of the calibration signal may be ±10% of the optimum drive frequency value for ultrasonic transducer 30.

Acoustic sensor 40 may be acoustically coupled to ultrasonic transducer 30. Acoustic sensor 40 may be configured for quantitatively sensing acoustic power output from ultrasonic transducer 30 in response to the calibration signal. Acoustic sensor 40 may have a frequency response extending at least over an operating frequency range of ultrasonic transducer 30. As a non-limiting example, acoustic sensor 40 may have a frequency response in the range of at least from about 3 to 12 MHz, and usually from about 6 to 12 MHz.

Acoustic sensor 40 may have a monotonic response over the calibration frequency range. That is to say, acoustic sensor 40 may respond proportionately to output from ultrasonic transducer 30, such that acoustic power levels sensed by acoustic sensor 40 are proportional to acoustic power emanating from ultrasonic transducer 30. Accordingly, a resonant frequency of ultrasonic transducer 30 may be determined by correlating a maximum acoustic power level with a corresponding frequency of the calibration signal.

With further reference to FIG. 1, re-calibration circuit 50 may be coupled to acoustic sensor 40 and to power supply 20. Re-calibration circuit 50 may be configured for receiving acoustic power output data from acoustic sensor 40, wherein the acoustic power output data may include power output levels corresponding to each of a plurality of frequencies at which ultrasonic transducer 30 was driven during a sweep of the calibration signal. Re-calibration circuit 50 may be further configured for comparing the acoustic power output data received from acoustic sensor 40. Re-calibration circuit 50 may include a comparison circuit (not shown), which may comprise a digital processor or an analog device. At certain time intervals the calibration signal may be provided by power supply 20 to ultrasonic transducer 30 as a swept frequency range. In an embodiment, the swept frequency range may be sampled at various incremental frequencies, wherein the increment size may be in the range of from about 100 Hz to 100 kHz, over a swept range of from about 3 MHz to 12 MHz.

Re-calibration circuit 50 may be configured for initiating a sweep of the calibration frequency range, and for determining increment size and sampling rate within the calibration signal. The swept frequency range may comprise at least three (3) increments, such that for each calibration signal, ultrasonic transducer 30 may be driven at three or more different frequencies. Typically, the calibration frequency range may comprise from about 256 to 4096 increments.

In an embodiment, re-calibration circuit 50 may be further configured for determining an optimum drive frequency value for ultrasonic transducer 30. The optimum drive frequency values may be determined based on maxima or minima in the received acoustic power output data. Re-calibration circuit 50 may be further configured for determining a selected drive frequency at which to drive ultrasonic transducer 30 at a working drive level, and for adjusting a frequency of a working drive signal of power supply 20 to the selected drive frequency value. The selected drive frequency may be determined by re-calibration circuit 50 based on the most recently determined optimum drive frequency and/or resonant frequency values. The selected drive frequency may be selected to provide at least substantially optimum acoustic power output by ultrasonic transducer 30. As non-limiting examples, re-calibration circuit 50 may use either a dithering scheme or a more complex frequency response analysis to determine the selected drive frequency for system 10.

Driving ultrasonic transducer 30 at precisely its resonant frequency may result in excessive distortion. According to one aspect of the invention, driving ultrasonic transducer 30 at the selected drive frequency may result in optimum acoustic power output, which may be at somewhat less than a maximum power level while resulting in acceptable (lower) levels of distortion. As used herein, optimum acoustic power output may be defined as acoustic power output that is closest to the maximum level, for a given ultrasound system and set of operating conditions, in the absence of an unacceptable level of distortion. Typically, for example, optimum acoustic power output may be at least about 70% of maximum acoustic power with a distortion level not more than about 10% of maximum distortion, usually at least about 80% of maximum acoustic power with a distortion level not more than about 7% of maximum distortion, and often at least about 85% of maximum acoustic power with a distortion level not more than about 5% of maximum distortion.

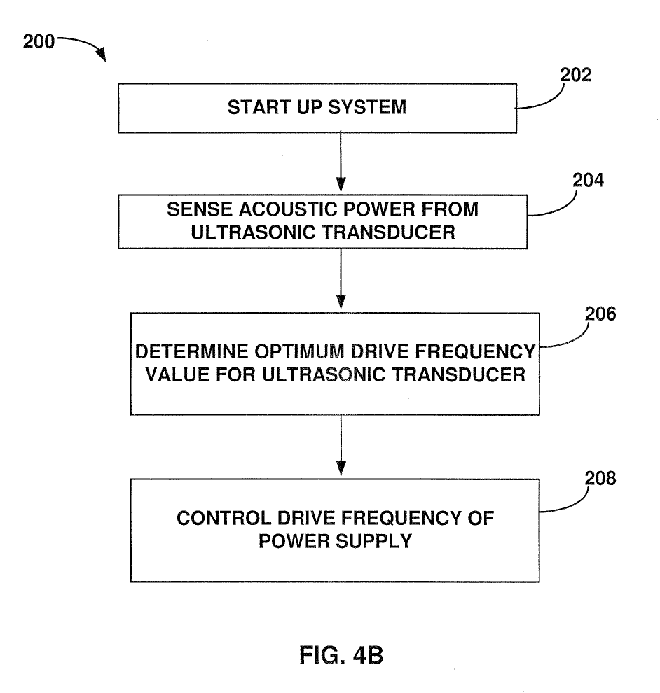

In an embodiment, ultrasound system 10 may be configured for providing the calibration signal to ultrasonic transducer 30 upon startup of ultrasound system 10 (see, e.g., FIG. 4). Ultrasound system 10 may be further configured for periodically providing the calibration signal to ultrasonic transducer 30 during operation of ultrasound system 10. In an embodiment, re-calibration circuit 50 may be configured for determining the bounds of a calibration frequency range of the calibration signal, as well as the rate of frequency sweep, and the size of increments to be sampled within the calibration frequency range.

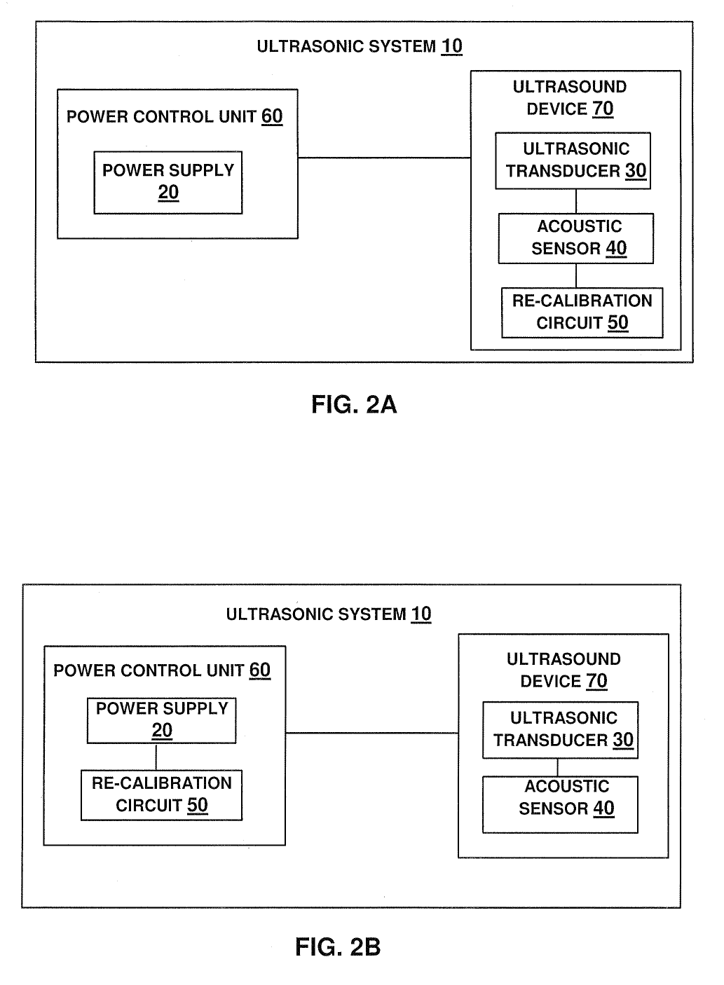

FIG. 2A schematically represents an ultrasound system 10, according to another embodiment of the invention. Ultrasound system 10 may include a power control unit 60 and an ultrasonic device 70. Power control unit 60 may include a power supply 20, e.g., substantially as described with reference to FIG. 1. In an embodiment, power control unit 60 may comprise a console housing power supply 20, together with one or more processors, one or more displays, a power switch, one or more user inputs, a memory, and an analog to digital (A/D) converter (not shown). It is to be understood that the invention is not limited to any particular configuration for power control unit 60.

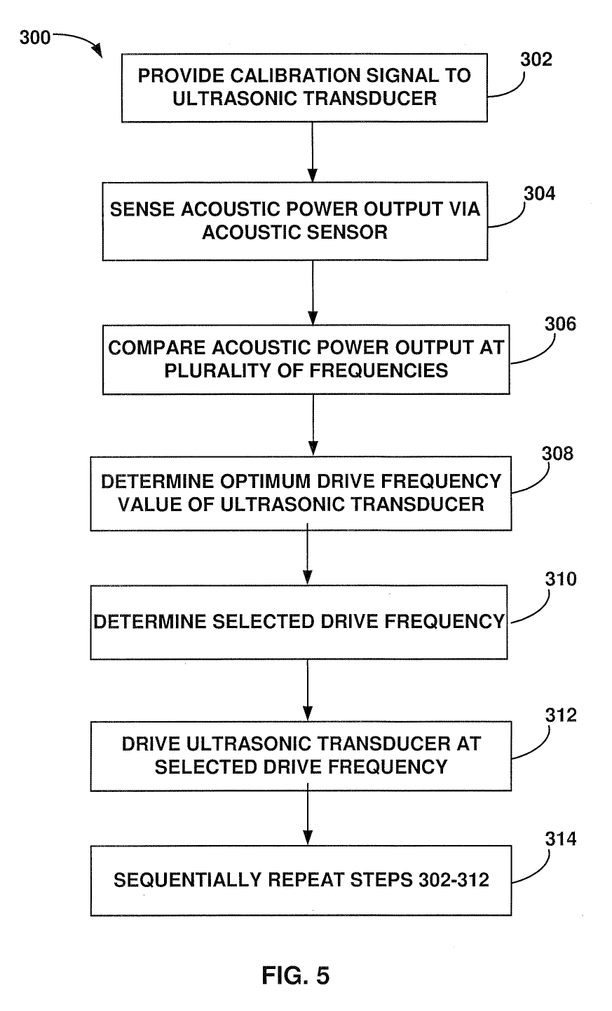

Ultrasonic device 70 may be coupled to power control unit 60 via suitable electrical connections, e.g., a cable and/or multi-pin connector. Power control unit 60 may be configured for driving ultrasonic device 70 via a working drive signal and/or a calibration signal (see, e.g., FIG. 1 and FIG. 5). Ultrasonic device 70 may include an ultrasonic transducer 30, an acoustic sensor 40, and a re-calibration circuit 50. Ultrasonic transducer 30, acoustic sensor 40, and re-calibration circuit 50 may be configured substantially as described for FIG. 1. Acoustic sensor 40 may have a fixed acoustic coupling to ultrasonic transducer 30. Ultrasonic transducer 30 may comprise various piezoelectric elements and materials known in the art. The invention is not limited to any particular type of transducer or piezoelectric components.

Ultrasonic device 70 may be adapted for providing acoustic power at a frequency range typically from about 3 to 12 MHz, usually from about 6 to 12 MHz, and often at least about 7 MHz. However, ultrasonic device 70 is not restricted to operation at any particular frequency. Ultrasonic device 70 may find applications in various medical procedures, as well as industrial processes, and the like. Ultrasonic device 70 is not limited to any particular types of applications. Although re-calibration circuit 50 is shown in FIG. 2A as being a component of ultrasonic device 70, in other embodiments re-calibration circuit 50 may be housed at least partially within power control unit 60 (see, e.g., FIG. 2B).

In an embodiment, ultrasound system 10 may further include a cooling system (not shown). An ultrasound system comprising a power supply, a controller, and a cooling system is disclosed in commonly assigned, co-pending patent application U.S. application Ser. No. 11/851,351, entitled Ultrasound System and Method for Hair Removal (U.S. Patent Application Publication No. 2008/0183110), the disclosure of which is incorporated by reference herein in its entirety.

FIG. 2B schematically represents an ultrasound system, according to another embodiment of the invention. Ultrasound system 10 may include a power control unit 60 coupled to an ultrasonic device 70, and having components substantially as described for the embodiment of FIG. 2A. However, in the embodiment of FIG. 2B at least part of re-calibration circuit 50 may be housed within power control unit 60. In some embodiments (not shown per se), re-calibration circuit 50 may be housed partly within power control unit 60 and partly within ultrasonic device 70. In some embodiments, circuitry may also be located at least partially within an electrical cable or other connection (e.g., a multi-pin connector element) disposed between power control unit 60 and ultrasonic device 70. In the embodiments of FIGS. 2A-B, re-calibration circuit 50 may function substantially as described with reference to FIGS. 1 and 5.

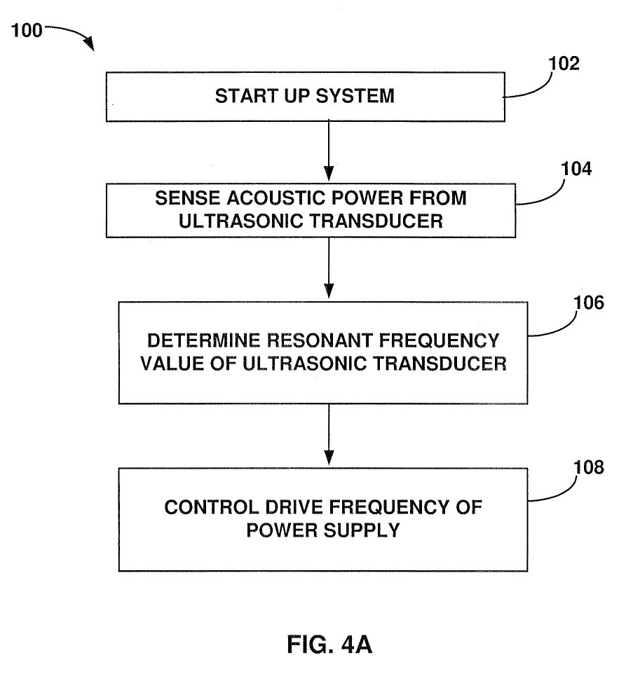

FIG. 3 is a block diagram schematically represents an ultrasonic device 70, according to another embodiment of the invention. In operation, ultrasonic device 70 may be coupled to a drive unit, such as power supply 20 (see, e.g., FIGS. 1, and 2A-B). Ultrasonic device 70 may include a transducer assembly 80 and a processor 90. Transducer assembly 80 may include an ultrasonic transducer 30 and an integral acoustic sensor 40. Ultrasonic transducer 30 and acoustic sensor 40 may be configured substantially as described herein, for example, with reference to FIG. 1.

With further reference to FIG. 3, ultrasonic transducer 30 may be configured for receiving a calibration signal comprising a calibration frequency range. The calibration signal may be provided by, for example, power supply 20 (see, e.g., FIG. 1). The calibration frequency range may span, or extend over, at least a resonant frequency range of ultrasonic transducer 30. Acoustic sensor 40 may have a fixed acoustic coupling to ultrasonic transducer 30. Acoustic sensor 40 may have a frequency response extending over at least an operating frequency range of ultrasonic transducer 30. Acoustic sensor 40 may have a monotonic response over the entire calibration frequency range of the calibration signal. Acoustic sensor 40 may be configured for sensing acoustic power output from ultrasonic transducer 30 for each of a plurality of frequencies within the calibration frequency range.

With further reference to FIG. 3, processor 90 may be coupled to acoustic sensor 40 for receiving and processing acoustic power output data. In an embodiment, processor 90 may be configured for comparing acoustic power output levels for each of the plurality of frequencies sampled from within the calibration signal. In an embodiment, processor 90 may be integral with transducer assembly 80. In some embodiments, ultrasonic device 70 may include an analog circuit or device for comparing acoustic power output data. The invention is not limited to any particular configuration or components of transducer assembly 80 or ultrasonic device 70.

Ultrasonic transducer 30 and acoustic sensor 40 may have various other features, characteristics, and functionality as described herein, e.g., with reference to FIGS. 1 and 5. In an embodiment, ultrasonic device 70 may comprise a probe or a handpiece configured for delivering ultrasound energy to a patient during a medical procedure. It is to be understood, however, that the invention is not limited to any particular therapeutic, diagnostic, or other medical applications.

FIG. 4A is a flow chart schematically representing steps in a method 100 for controlling a power supply of an ultrasound system, according to another embodiment of the invention. Step 102 may involve starting up the ultrasound system. The ultrasound system may be started up by turning on a power switch, which may be located, for example, on a console or power control unit of the ultrasound system. The ultrasound system may additionally or alternatively include a footswitch (not shown). The ultrasound system may include a drive unit or power supply and a re-calibration circuit (see, e.g., FIGS. 1-3).

In an embodiment, the ultrasound system may include an ultrasonic device, such as a handpiece. In an embodiment, the ultrasonic device or handpiece may include one or more switches. The ultrasonic device or handpiece may include an ultrasonic transducer and an acoustic sensor acoustically coupled to the ultrasonic transducer (see, e.g., FIG. 3). The ultrasound system may be programmed to drive the ultrasonic transducer via a calibration signal provided from the power supply to the ultrasonic transducer in response to startup of the ultrasound system. The instant invention provides for adjustment of the drive frequency, via the calibration signal, to compensate for resonant frequency drift which may be inherent in the ultrasonic transducer, thereby maintaining operation of ultrasound systems of the invention at optimum efficiency.

Step 104 may involve sensing acoustic power output from the ultrasonic transducer in response to the calibration signal. The calibration signal may comprise a calibration frequency range spanning at least the operating frequency range of the ultrasonic transducer. The acoustic power outputted from the ultrasonic transducer in response to the calibration signal may be sensed by the acoustic sensor. The acoustic sensor may have a monotonic frequency response spanning the calibration frequency range. During step 104 the acoustic sensor may sense acoustic power output levels for each of a plurality of frequencies within the calibration frequency range.

Step 106 may involve determining a resonant frequency value of the ultrasonic transducer. Step 106 may include comparing, e.g., via the re-calibration circuit, the acoustic power output levels sensed according to step 104. In an embodiment, the resonant frequency value may be determined as the frequency, within the calibration frequency range of the calibration signal, which provides maximum acoustic power output from the ultrasonic transducer.

Step 108 may involve controlling a drive frequency to the ultrasonic transducer. The drive frequency may be controlled by tuning the power control unit (see, e.g., FIGS. 2A-B) to drive the ultrasonic transducer at a selected drive frequency, wherein the selected drive frequency may be determined based on the resonant frequency value of step 106. According to various embodiments of the invention, the selected drive frequency may be equal to the resonant frequency value, greater than (>) the resonant frequency value, or less than (<) the resonant frequency value. The selected drive frequency may typically be in the range of ±10% of the resonant frequency value, i.e., from about +10% of the resonant frequency value to about −10% of the resonant frequency value.

In an embodiment, the selected drive frequency may be selected or determined such that driving the ultrasonic transducer precisely at its resonant frequency is avoided. In an embodiment, the selected drive frequency may be selected to lie outside a relatively narrow range of frequencies spanning the resonant frequency value. As a non-limiting example, the selected drive frequency may lie within the broader range of ±10% of the resonant frequency value but may lie outside, or exclude, the range of ±1% of the resonant frequency value. In an embodiment, the selected drive frequency may at least substantially correspond to an optimum drive frequency value, i.e., the drive frequency providing optimum acoustic power output. Optimum acoustic power output may be defined herein as acoustic power output that is closest to the maximum level, for a given ultrasound system and set of operating conditions, in the absence of an unacceptable level of distortion.

FIG. 4B is a flow chart schematically representing steps in a method 200 for controlling a power supply of an ultrasound system, according to another embodiment of the invention. As a non-limiting example, method 200 may be applicable to embodiments comprising high frequency fundamental transducers which may lack well defined resonant features at their optimum drive frequency.

Step 202 of method 200 may involve starting up the ultrasound system, for example, substantially as described for step 102 of method 100 (see, e.g., FIG. 4A, supra). The ultrasound system may include elements and features as described herein, e.g., with reference to FIGS. 3 and 4A, supra.

Step 204 may involve sensing acoustic power output from the ultrasonic transducer in response to the calibration signal, e.g., substantially as described with reference to method 100, step 104 (FIG. 4A).

Step 206 may involve determining an optimum drive frequency value of the ultrasonic transducer. Step 206 may include comparing, e.g., via the re-calibration circuit, the acoustic power output levels sensed according to step 204. In an embodiment, the optimum frequency value may be determined as the frequency, within the calibration frequency range of the calibration signal, which provides maximum acoustic power output from the ultrasonic transducer within the acceptable range of waveform distortion. The “optimum acoustic power output” may be defined herein as acoustic power output that is closest to the maximum level, for a given ultrasound system and set of operating conditions, in the absence of an unacceptable level of distortion, substantially as described hereinabove.

Step 208 may involve controlling a drive frequency to the ultrasonic transducer. The drive frequency may be controlled by tuning the power control unit to drive the ultrasonic transducer at a selected drive frequency, wherein the selected drive frequency may be determined based on the optimum frequency value of step 206. According to various embodiments of the invention, the selected drive frequency may be equal to the optimum drive frequency value, greater than (>) the optimum drive frequency value, or less than (<) the optimum drive frequency value. The selected drive frequency may typically be in the range of ±10% of the optimum drive frequency value, i.e., from about +10% of the optimum drive frequency value to about −10% of the optimum drive frequency value.

FIG. 5 is a flow chart schematically representing steps in a method 300 for controlling a power supply, according to another embodiment of the invention. The power supply may be configured for driving an ultrasonic transducer in an ultrasound system (see, e.g., FIGS. 1-3). The ultrasonic transducer may be a component of an ultrasonic device, e.g., comprising a probe or handpiece. In an embodiment, the ultrasonic device may be configured for the highly controlled delivery of ultrasonic acoustic power to a patient, e.g., during a medical procedure.

Step 302 may involve providing a calibration signal to the ultrasonic transducer. The calibration signal may be provided from the power supply. The calibration signal may be provided in response to startup of the ultrasound system. The ultrasound system may include a re-calibration circuit, and the re-calibration circuit may prompt the power supply to periodically provide the calibration signal during operation of the ultrasonic transducer/ultrasound system, as well as at startup of the system. In an embodiment, during use of the ultrasound system for a medical procedure or other application, the calibration signal may be provided with a periodicity of about one (1) minute or less. As a non-limiting example, the calibration signal may typically be provided with a periodicity of from about 10 seconds to 30 seconds, and often from about 10 seconds to 20 seconds.

The calibration signal may comprise a calibration frequency range. The calibration frequency range may typically have a minimum frequency of at least about 3 MHz, usually at least about 5 MHz, and often at least about 7 MHz. The calibration frequency range, as well as the manner of sampling the calibration signal, e.g., increment size and sweep rate, may be under the control of the re-calibration circuit. The calibration signal may have a relatively low drive level, for example, as compared with a substantially higher drive level of a working drive signal for delivering acoustic power via the ultrasonic device.

Step 304 may involve sensing acoustic power output from the ultrasonic transducer in response to each of a plurality of frequencies of the calibration signal. In an embodiment, not all frequencies within the frequency range of the calibration signal may be sampled. At least in embodiments wherein sampling of the calibration signal is under the control of a digital processor, only certain increments within the calibration frequency range may be sampled. Regardless of the increment size or sampling rate of the calibration signal, the acoustic power output from the ultrasonic transducer may be sensed by an acoustic sensor, which may have a fixed acoustic coupling to the ultrasonic transducer. The acoustic sensor may have a monotonic response to the acoustic power output over the entire calibration frequency range.

Step 306 may involve comparing acoustic power output levels, sensed by the acoustic sensor according to step 304, for each of the plurality of frequencies sampled from within the calibration signal. Step 308 may involve determining an optimum drive frequency value for the ultrasonic transducer. The optimum drive frequency value may be based on the frequency that provides maximum acoustic power output from the ultrasonic transducer within the acceptable range of waveform distortion (see, e.g., method 200, step 206 (FIG. 4B)). In an embodiment, step 308 may involve determination of a resonant frequency value of the ultrasonic transducer (see, e.g., method 100, FIG. 4A).

Step 310 may involve determining a selected drive frequency at which to drive the ultrasonic transducer with a working drive signal. Steps 306-310 may be under the control of the re-calibration circuit. Determination of the selected drive frequency may be based on the optimum drive frequency value determined for the ultrasonic transducer according to step 308. In an embodiment, the total time required to complete steps 302 through 310 may typically be less than one (1) second, and often about 0.5 seconds.

In an embodiment, the selected drive frequency may typically have a frequency in the range of ±10% of the determined optimum drive frequency value, usually in the range of ±5% of the optimum drive frequency value, and often in the range of ±2% of the optimum drive frequency value. In an embodiment, the selected drive frequency may be at least substantially equal to the optimum drive frequency value.

The level of the calibration signal provided in step 302 may be at least substantially less than the drive level of the working drive signal. In an embodiment, a second drive level of the working drive signal may typically be at least about twice (2×) that of a first drive level of the calibration signal, usually at least about fivefold (5×) that of the first drive level, and often at least about tenfold (10×) that of the first drive level.

Step 312 may involve driving the transducer at the selected drive frequency. The re-calibration circuit may be configured to control the power supply. For example, if the frequency of the drive signal from the power supply differs from the selected drive frequency, the power supply may be adjusted such that the power supply drives the ultrasonic transducer at the selected drive frequency. By adjusting the power supply to drive the ultrasonic transducer at the selected drive frequency, the acoustic power level provided by the ultrasonic transducer can be accurately controlled, and at the same time the ultrasound system can be operated efficiently, e.g., with optimum acoustic power output.

According to one aspect of the invention, the selected drive frequency may be determined based on the resonant frequency value of the ultrasonic transducer (see, e.g., FIG. 4A). In an embodiment, the selected drive frequency may be approximately equal to the resonant frequency value of the ultrasonic transducer. In some embodiments, the selected drive frequency may be selected such that the selected drive frequency does not equal the resonant frequency value. For example, in some embodiments the ultrasonic transducer may be purposely driven at a frequency other than the resonant frequency value, e.g., at a drive frequency providing almost maximum acoustic power but with relatively low levels of distortion. Such acoustic power output, which is close to a maximum value attainable for a given ultrasound system and set of operating conditions while having acceptable levels of distortion, may be referred to herein as optimum acoustic power.

According to another aspect of the invention, a selected or optimum drive frequency value may be determined, for example, based on a frequency within the calibration frequency range that provides maximum acoustic power output from the ultrasonic transducer within the acceptable range of waveform distortion; and such drive frequency value may be determined without determination of resonant frequency value(s) for the ultrasonic transducer (see, e.g., FIG. 4B).

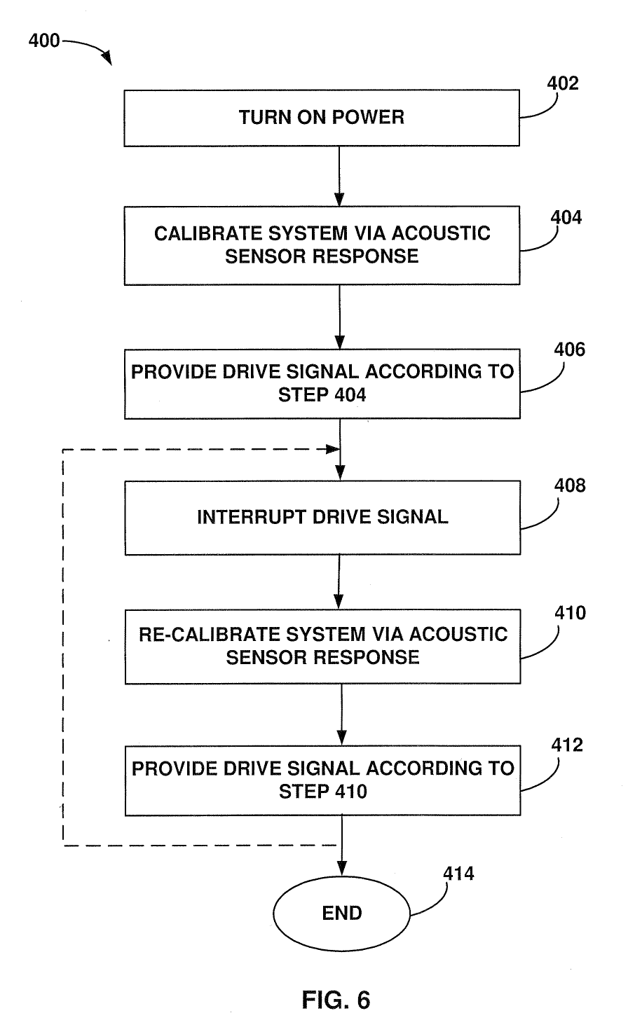

Step 314 may involve sequentially repeating steps 302 through 312. In an embodiment, steps 304 through 312 may be performed sequentially in response to the provision of a calibration signal to the ultrasonic transducer. The calibration signal may be provided periodically during operation of the ultrasound system. During provision of the calibration signal (per step 302), step 312 may be transiently interrupted such that the drive signal does not interfere with the calibration signal (see, e.g., FIG. 6, step 408, infra). In an embodiment, the calibration signal can be provided repeatedly such that any significant frequency drift experienced by the ultrasonic transducer during operation, e.g., due to changing operating conditions, can be corrected for by re-calibrating the power supply shortly after the occurrence of such frequency drift. The calibration signal may additionally or alternatively be provided in response to startup of the ultrasound system.

FIG. 6 is a flow chart schematically representing steps in a method 400 for calibrating an ultrasound system, according to another embodiment of the invention. The ultrasound system may include elements and features, such as an ultrasonic transducer coupled to a high frequency power supply, e.g., substantially as described with reference to FIGS. 1 and 4A. Step 402 may involve turning on power to the ultrasound system. Step 404 may involve calibrating the ultrasound system via an acoustic sensor's response to a calibration signal. As an example, calibration in step 404 may involve comparing acoustic power output at each of a plurality of frequencies within the calibration signal to determine an optimum frequency value at which to drive a transducer of the ultrasound system. In an embodiment, the optimum frequency value may represent a drive frequency that provides optimum acoustic power output by the ultrasound system.

Step 406 may involve providing a drive signal, via a power supply, to the transducer for producing acoustic power. The frequency of the drive signal provided in step 406 may be based on step 404. Step 408 may involve interrupting the drive signal to the ultrasonic transducer. The drive signal may be briefly interrupted during operation of the ultrasound system preparatory to provision of the calibration signal to the transducer. The calibration signal may be provided periodically during operation of the ultrasound system (see, e.g., FIG. 5, step 314), and the drive signal may be interrupted during provision of each periodically provided calibration signal.

Step 410 may involve re-calibrating the ultrasound system. Step 410 may be performed substantially as described for step 404, supra. Step 412 may involve driving the ultrasonic transducer via a drive signal from the power supply. The frequency of the drive signal provided in step 412 may be based on step 410. In an embodiment, the transducer may be driven at an optimum drive frequency value determined according to step 410. Steps 408-412 may be sequentially repeated, on a periodic basis, during operation of the ultrasound system, e.g., until operation of the ultrasound system is stopped or power to the system is turned off (414).

The instant invention is not restricted to any particular type of ultrasound applications, systems, or devices; but rather, apparatus and methods of the invention may be used in conjunction with various medical-related procedures as well as non-medical applications, e.g., industrial processes, and the like.

It is to be understood that the foregoing relates to exemplary embodiments of the invention, and that methods, systems, and apparatus of the invention may find many applications other than those described herein. None of the examples presented herein are to be construed as limiting the present invention in any way; modifications may be made without departing from the spirit and scope of the invention as set forth in the following claims.

1. A method for controlling a power supply of an ultrasound system, comprising:
a) via an acoustic sensor, sensing acoustic power output from an ultrasonic transducer; and
b) in response to said acoustic power output, controlling a drive frequency of said power supply.

2. The method of claim 1, wherein:
step a) comprises sensing acoustic power output at each of a plurality of frequencies, and
said plurality of frequencies lie within a frequency range of a calibration signal provided to said ultrasonic transducer.

3. The method of claim 2, further comprising:
c) based on said acoustic power output sensed in step a), determining an optimum drive frequency value for said ultrasonic transducer.

4. The method of claim 3, wherein step c) comprises determining a resonant frequency value of said ultrasonic transducer.

5. The method of claim 3, further comprising:
d) via said power supply, providing a working drive signal to said ultrasonic transducer at said optimum drive frequency, wherein said optimum drive frequency provides optimum acoustic power output by said ultrasonic transducer.

6. The method of claim 3, wherein steps a) through c) are sequentially performed in response to each startup of said ultrasound system.

7. A method for tuning a power supply, comprising:
a) providing a calibration signal to an ultrasonic transducer;
b) via an acoustic sensor, sensing acoustic power outputted from said ultrasonic transducer in response to said calibration signal;
c) based on said acoustic power sensed in step b), determining an optimum drive frequency value for said ultrasonic transducer, and
d) based on said optimum drive frequency value determined in step c), driving said ultrasonic transducer at a selected drive frequency, wherein said selected drive frequency provides at least substantially optimum acoustic power output from said ultrasonic transducer.

8. The method of claim 7, wherein said selected drive frequency is at least substantially equal to said optimum drive frequency value.

9. The method of claim 7, wherein said optimum drive frequency value is at least about 7 MHz.

10. The method of claim 7, wherein:
step a) comprises providing said calibration signal over a swept frequency range, and
step c) comprises comparing acoustic power output levels from said ultrasonic transducer for each of a plurality of frequencies within said swept frequency range.

11. The method of claim 7, wherein:
said ultrasonic transducer is coupled to a power supply in an ultrasound system,
steps a)-c) are performed sequentially in response to startup of said ultrasound system, and
steps a)-c) are periodically repeated sequentially during operation of said ultrasound system.

12. The method of claim 7, wherein:
said selected drive frequency comprises a frequency within the range of from about +10% of the resonant frequency value of said ultrasonic transducer to −10% of said resonant frequency value, and
said selected drive frequency comprises a frequency outside the range of from about +1% of said optimum frequency value to −1% of the resonant frequency value.

13. The method of claim 7, wherein step c) comprises determining said optimum drive frequency value based on a frequency of said calibration signal which provides maximum acoustic power output from said ultrasonic transducer within an acceptable range of waveform distortion.

14. The method of claim 7, wherein:
step c) comprises determining a resonant frequency value of said ultrasonic transducer, and
said resonant frequency value is at least about 5 MHz.

15. A method of operating an ultrasound device for treatment of tissue, said ultrasound device including an ultrasound transducer and a power supply generating a high frequency output, said method comprising the steps of:
a) driving said transducer over a range of operating frequencies;
b) monitoring the output of said transducer with an acoustic sensor and generating output signals in response thereto;
c) selecting an optimum drive frequency based on said output signals; and
d) driving said transducer at said optimum drive frequency during the treatment of the tissue.

16. The method of claim 15, wherein steps a), b) and c) are periodically repeated to in order to maintain an optimum drive frequency.

17. The method of claim 15, wherein step a) is performed by driving said transducer over a range of at least 3 MHz.

18. The method of claim 15, wherein the power of the drive frequency supplied to said transducer in step d) is greater than the power of the drive frequency supplied to said transducer in step a).

19. The method of claim 15, wherein said optimum drive frequency is selected to be between +10% and −10% of the resonant frequency of said transducer.

20. The method of claim 15, wherein said optimum drive frequency is selected to be at least one percent greater than or less than the resonant frequency of said transducer.

21. An ultrasonic device, comprising;
a transducer assembly including an ultrasonic transducer; and
an acoustic sensor having a fixed acoustic coupling to said ultrasonic transducer, wherein:
said acoustic sensor has a frequency response extending over at least an operating frequency range of said ultrasonic transducer,
said ultrasonic transducer is configured for receiving a calibration signal comprising a calibration frequency range, and
said acoustic sensor is configured for sensing acoustic power output from said ultrasonic transducer for each of a plurality of frequencies within said calibration frequency range.

22. The ultrasonic device of claim 21, wherein:
said acoustic sensor has a monotonic response over said calibration frequency range, and
said calibration frequency range spans an optimum drive frequency value for said ultrasonic transducer.

23. The ultrasonic device of claim 21, wherein:
said calibration frequency range spans a resonant frequency of said ultrasonic transducer, and
said resonant frequency is at least about 5 MHz

24. The ultrasonic device of claim 21, wherein said acoustic sensor is integral with said transducer assembly.

25. The ultrasonic device of claim 21, wherein:
said transducer assembly further includes an integral processor coupled to said acoustic sensor, and
said processor is configured for comparing acoustic power output levels for said plurality of frequencies.

26. An ultrasound system, comprising:
a power supply;
an ultrasonic transducer coupled to said power supply;
an acoustic sensor acoustically coupled to said ultrasonic transducer; and
a re-calibration circuit coupled to said acoustic sensor and to said power supply, wherein:
said ultrasonic transducer is configured for receiving a calibration signal comprising a calibration frequency range, and
said acoustic sensor is configured for sensing acoustic power output from said ultrasonic transducer for each of a plurality of frequencies within said calibration frequency range.

27. The system of claim 26, wherein said re-calibration circuit is configured for determining an optimum drive frequency value for said ultrasonic transducer in response to said acoustic power output from said ultrasonic transducer responsive to said calibration signal.

28. The system of claim 26, wherein said re-calibration circuit is configured for determining a resonant frequency value for said ultrasonic transducer in response to said acoustic power output from said ultrasonic transducer responsive to said calibration signal.

29. The system of claim 28, wherein:
said re-calibration circuit is configured for receiving power output data from said acoustic sensor,
said power output data comprises an acoustic power output level for each of said plurality of frequencies, and
said resonant frequency value is determined by comparing said acoustic power output levels.

30. The system of claim 28, wherein:
said re-calibration circuit is configured for determining a selected drive frequency based on said resonant frequency value, and
said re-calibration circuit is further configured for adjusting said power supply to provide said selected drive frequency to said ultrasonic transducer.

31. The system of claim 26, wherein:
said acoustic sensor has a fixed acoustic coupling to said ultrasonic transducer,
said acoustic sensor has a monotonic response over said calibration frequency range, and
said ultrasound system is configured for providing said calibration signal to said ultrasonic transducer upon startup of said ultrasound system.
